(19) United States
(12) Patent Application Publication
(10) Pub. No.: US 2012/0324781 A1
(43) Pub. Date: Dec. 27, 2012

(54) Bed bug and roach trap

(76) Inventor: Everett J. Smiley, Oakford, IN (US)

(21) Appl. No.: 13/135,097

(22) Filed: Jun. 24, 2011

(51) Int. Cl. A01M 1/10

(52) U.S. Cl. 43/123

(57) ABSTRACT

The present invention relates generally to traps for bed bugs and roaches. Bed bug infestations have taken a dramatic upturn in the last several years and roaches are among the oldest surviving creatures on earth. This trap takes a novel approach to luring bed bugs and/or roaches out of their hiding places, using a live warm blooded animal to entice them into the trap and killing them once they enter the trap by cutting their legs off with a rotating cutter blade, shearing off any protrusion through the perforations in an interior wall.

### BACKGROUND

1. Field of Invention

The present invention relates generally to traps for bed bugs and roaches. Bed bug infestations have taken a dramatic upturn in the last several years and roaches are among the oldest surviving creatures on earth. This trap takes a novel approach to luring bed bugs and/or roaches out of their hiding places into the trap and killing them once they enter the trap.

2. Prior Art

Since Bed bugs are blood sucking creatures most traps used against them have used virtual or simulated warm blooded animals as bait to lure the insects into a trap. Some have used a heat source to mimic a warm blooded animal, some use sonic beats to simulate a beating heart, some give off carbon dioxide to simulate the out-breath of a warm blooded animal or other byproducts of a warm blooded animal's digestive or respiratory systems. Some even make the heat source move to simulate an animal's movement. Numerous improvements have been attempted since then but none have disclosed a unit that is relatively light weight and easy to move from one place to another and operates without complex and expensive simulators and uses a live animal to attract the pests.

### SUMMARY OF THE INVENTION

An object of the Bed Bug and Roach Trap is to provide a system that allows bed bugs or roaches to be lured from their hiding places and once into the trap have their legs sheared off causing them to fall into a disposable bag or container.

Another object of the Bed Bug and Roach Trap is to provide a system that is relatively light in weight and easily repositioned from room to room to trap and kill nocturnal pests.

Another object of the Bed Bug and Roach Trap is to provide a system that is relatively inexpensive to construct.

Another object of the Bed Bug and Roach Trap is to provide a system that is easy to disassemble into component parts for cleaning, storage and shipping.

Still further objects and advantages will become apparent from a consideration of the ensuing description and accompanying drawings. In the description, reference is made to the accompanying drawings which form a part thereof, and in which are shown, by way of illustration, specific embodiments in which the invention may be practiced. These embodiments will be described in sufficient detail to enable those skilled in the art to practice this invention, and be understood that other embodiments may be utilized and that structural changes may be made without departing from the scope of the invention. In the accompanying drawings, like reference characters designate the same or similar parts throughout the several views.

### DRAWINGS

The invention is described with reference to the following drawings:

FIG. 1 is a top plan view of the Bed Bug and Roach Trap;

FIG. 2 is a section view taken along cutting plane 2-2 in FIG. 1;

FIG. 3 is a partial section view of top plate assembly;

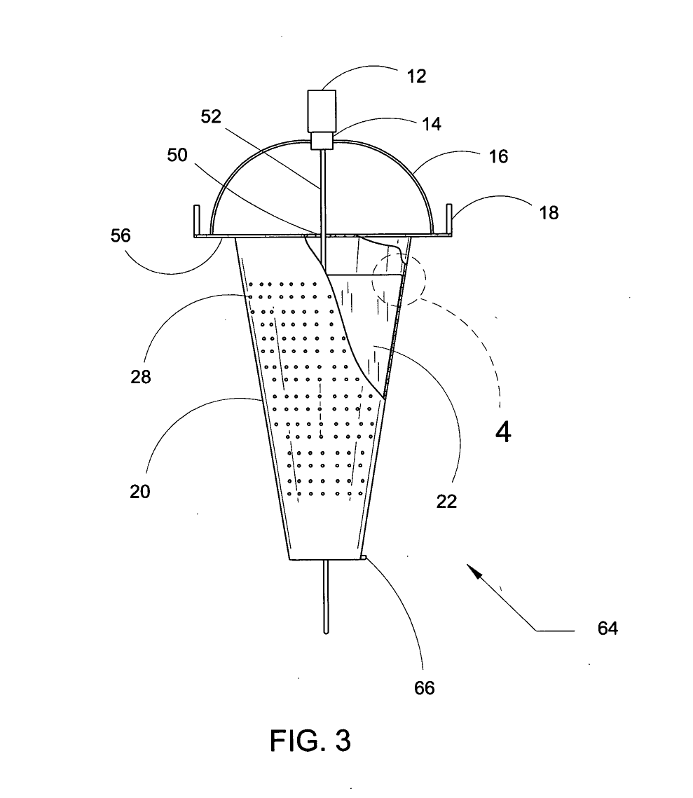

FIG. 4 is an enlarged partial view thereof;

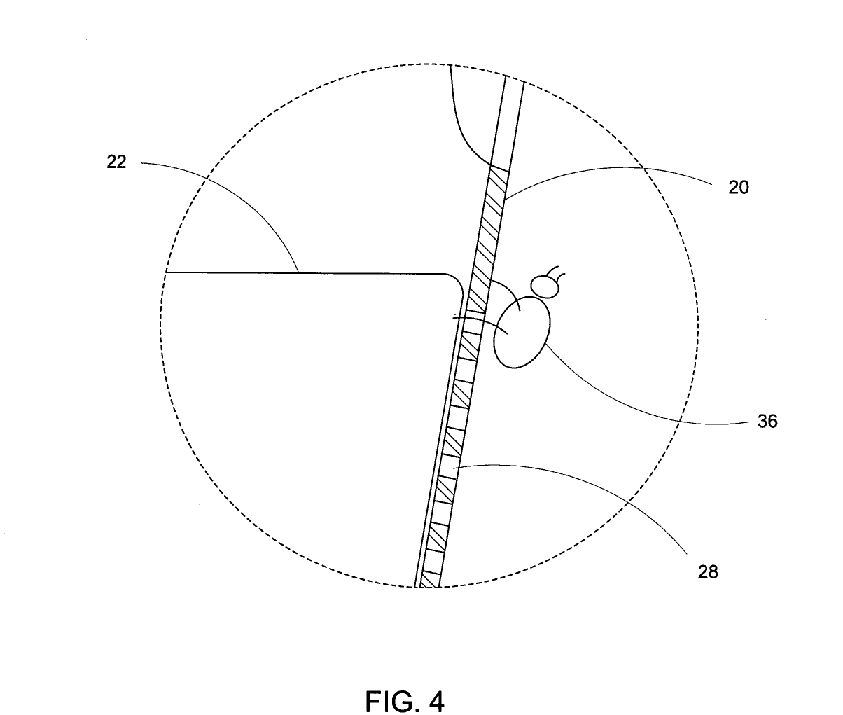

FIG. 5 is a partial section view of case assembly;

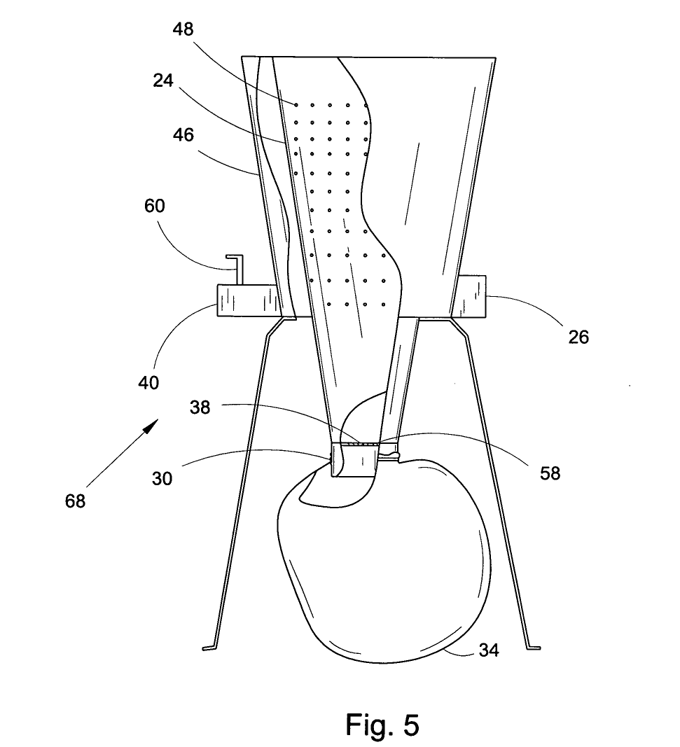

### DESCRIPTION

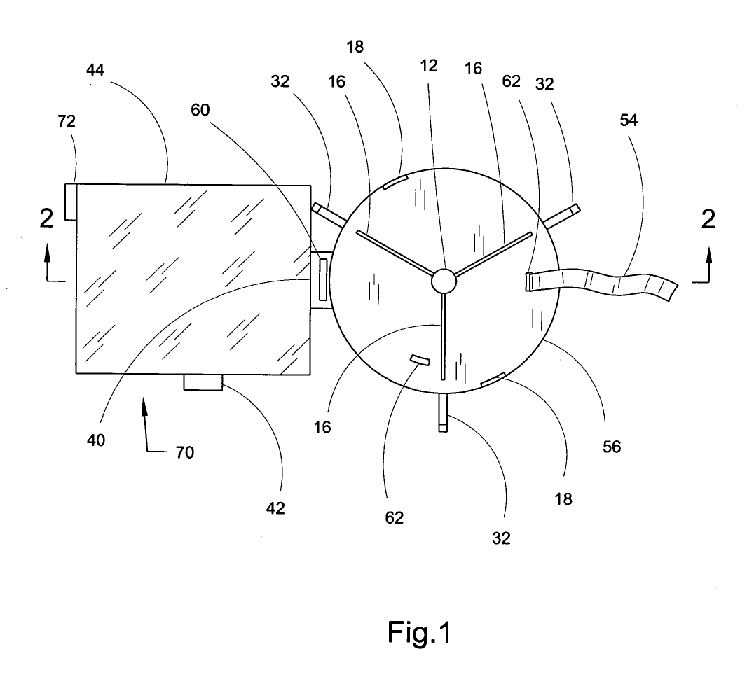

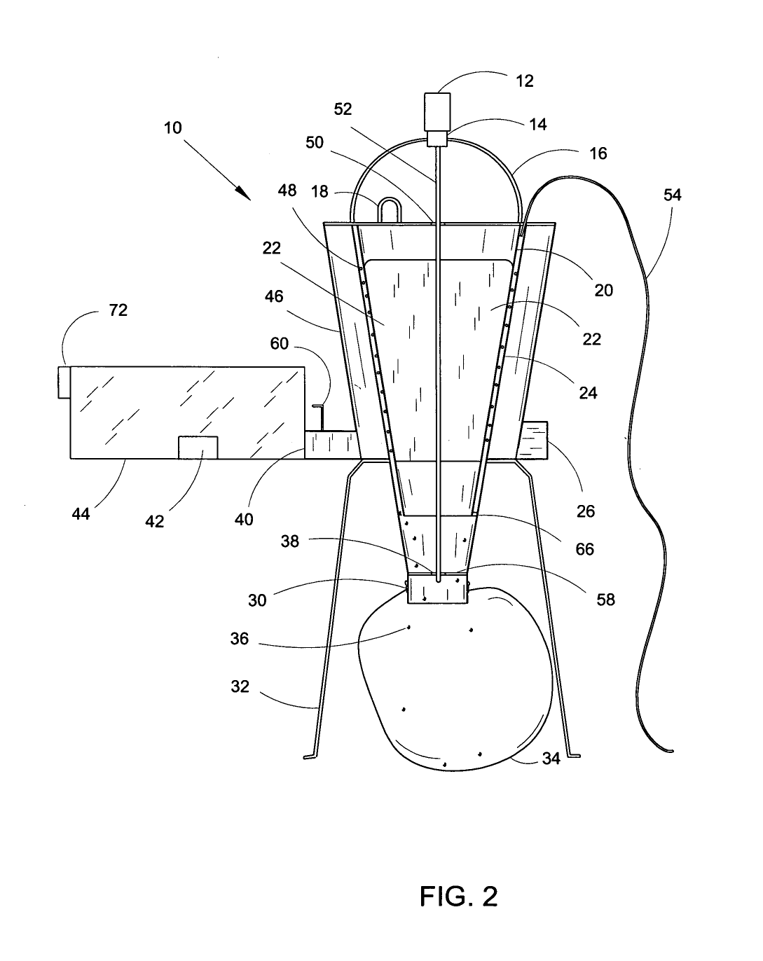

In order that the invention is fully understood it will now be described by way of the following examples in which Bed Bug and Roach Trap 10 is shown in FIGS. 1 and 2 with cage assembly 70 shown in schematic form with water supply 42 and air movement system 72. Cage assembly 70 is connected to case assembly 68 by animal run 40 with top plate assembly 64 installed in and on top of trap case assembly 68.

Case assembly 68 is comprised of trap case 46 which is cylindrical with an open top, a bottom with a hole in the center and is mounted on at least 3 support legs 32. Outer basket 24 is concentrically fastened inside trap case 46 with approximately ⅓ of the height of outer basket 24 protruding below the bottom of trap case 46. Outer basket 24 has a truncated conical shape with the large diameter at the top and the smaller diameter at the bottom. The hole in the bottom of trap case 46 is of a matching diameter to the diameter of truncated conical shaped outer basket 24 at the point that when outer basket 24 is concentrically mounted inside trap case 46, the top surface of cylindrical trap case 46 is at the same level as the top edge of outer basket 24. Outer basket 24 has a straight section wall depending from the small diameter with a bag attachment means 30 for a disposable bag 34 to capture the damaged bugs 36 as they fall. Bag attachment means 30 can be as simple as an elastic band over bag 34 around the straight wall section which may have a small external bump to aid in retention. At the beginning of the straight wall section, four radial bottom bearing support rods 58 are connected from the inside of the bottom diameter of outer basket 24 to the outside diameter of the raceway for bottom bearing 38. Bottom bearing 38 is sized to allow insertion of drive shaft 52.

Outer basket 24 has evenly spaced rows of perforations 48 that are smaller in diameter than the smallest cross sectional area of the bed bug or roach, preferably 0.20 inches or less, such that the bug can see and smell the bait animal but cannot crawl through perforation 48.

Top plate assembly 64 is comprised of top plate 56 that is a round steel plate that fits on the top of trap case 46. Top plate 56 has two handle/latches 18 on the top side toward the outer diameter of plate 56 that are used to lift and place top plate assembly 64 onto trap case 46. When handle/latches 18 are rotated to a horizontal attitude they activate a latching mechanism that holds top plate assembly 64 to trap case 46. Top plate 56 also has at least one vent 62 through plate 64 at a matching radius from the center of plate 56 to the outside of the large diameter of inner basket 20. Top plate assembly 64 is further comprised of motor 12 with timer 14 supported above the center of top plate 56 by at least 3 stabilizer bars 16. Top plate 56 has top bearing 50 at its center, sized to fit the outside diameter of drive shaft 52. Drive shaft 52 has at least one steel cutting blade 22 axially attached whose distal edge shape matches the shape of inner basket 20. Drive shaft 52 with cutter blade 22 attached is inserted through top bearing 50 and keyed to motor 12. Inner basket 20 is then concentrically fastened to the bottom of top plate 56. Inner basket 20 is shorter than outer basket 24 and enough smaller in top and bottom diameter to allow sufficient clearance between inner basket 20 and outer basket 24 to allow the bugs to crawl in-between them while trying to reach the bait animal, preferably approximately 0.5 inches. Inner basket 20 also has a truncated conical shape again with evenly spaced rows of perforations 28. These perforations 28 again are small enough to prevent the bugs from crawling through them. Bed bug or roach legs are likely to protrude through perforations 28 and be subject to amputation when cutter bade 22 is cycled while bugs are pursuing the bait animal. The vertical span of the rows of perforations 28 is slightly less than the vertical height of the cutting blade 22 and positioned such that cutter blade 22 when installed on drive shaft 52 covers all perforations 28 in inner basket 20. At the bottom and outside of inner basket 20, 3 evenly spaced spacer blocks 66 are attached to assure consistent spacing between inner basket 20 and outer basket 24.

Cage assembly 70 is comprised of animal cage 44 that has water supply 42 for the bait animal, preferably a mouse. Animal cage 44 is connected to Trap 10 by animal run 40. Animal run 40 is opened or closed by lifting or lowering shut-off gate 60. When shut-off gate 60 is raised it allows the bait animal to enter trap case 46 and move freely back and forth from water supply 42 in cage 44 to feed supply 26 mounted to opposite side of trap case 46.

Animal cage 44 is enclosed with a transparent material and has air movement system 72 that drives any odors that are attractive to bed bugs or roaches from cage 44 through animal run 40 into case assembly 68 and out vents 62 in top plate 56.

### Operation

Trap 10 is set in a room where roach or bed bug activity is suspected. Water for the bait animal is placed in water supply 42. A bait animal, preferably a mouse, is placed in cage 44 and animal run gate 60 is lifted, allowing the bait animal access to trap case 46. Animal food supply 26 is mounted on case 46 opposite cage 44 side and is filled and made available to bait animal which causes it to cycle back and forth with some regularity between water supply 42 in cage 44 and food supply 26 in trap case 46. The distal end of cloth strip bug ladder 54 is inserted into vent 62 and the proximal end is allowed to drag on the floor providing a path for bugs or roaches to enter Trap 10. Disposable bag 34 is attached to bottom of outer basket 24 with attachment means 30 to capture the dead or damaged bugs 36.

Motor 12 is cycled at preset intervals for predetermined lengths of time by timer 14. As it cycles, it rotates drive shaft 52 which drives cutter blade 22. Cutter blade 22 clears inner basket 20 by 0.002/0.005 Inches such that if any bug legs are protruding through perforations 28 they are amputated by cutter blade 22 and dead or damaged bugs 36 fall into disposable bag 34.

Although this invention has been described by detailing a preferred embodiment it is not intended to be limited to this set of materials and dimensions. Rather, the scope of this invention is defined by the following claims.

What is claimed is:

1. A trap for bed bugs and roaches comprising:
a cage for a warm blooded bait animal, encased to prevent access to said bait animal by bed bugs and roaches, connected to a trap case by an animal run where said trap case has a cylindrical exterior wall, a top plate, a bottom, a first interior concentric wall and a second further interior concentric wall, where said bait animal is allowed to run between said exterior wall and said first interior wall and the bed bugs and roaches are enticed to enter the space between said first interior wall and said second interior wall through vents in said top plate to pursue said bait animal, said interior walls having rows of perforations small enough to prevent ingress or egress of bed bugs or roaches but large enough to allow their legs to protrude though said perforations, a cutter blade mounted to a drive shaft rotated by a motor at predetermined intervals for predetermined periods of time, where said motor with timer is mounted to said top of said top plate and said cutter blade rotates with approximately a 0.002/0.005 inch clearance to said second interior wall such that legs sticking through will be amputated, causing dead or damaged insects to fall through an opening in the bottom of said trap case into a disposable bag attached to bottom of said trap case.

2. A trap for bed bugs and roaches comprising:
a case assembly connected to a cage assembly by an animal run with a shut-off gate comprised of:
a cylindrical trap case with a height, a diameter, a top edge, a bottom, supported by at least
three support legs connected to said bottom with a hole in center of said bottom;
an outer basket concentrically located inside said cylindrical trap case that has a truncated conical shape with the large diameter at the top and the small diameter at the bottom, where said top edge of said cylindrical trap case is level with said large diameter at said top of said truncated conically shaped outer basket and said hole in said bottom has a diameter to match the diameter of said conical shape at a point that allows approximately ⅓ of the height of said conical shape to protrude beneath said bottom leaving sufficient space between said trap case wall and said outer basket for said bait animal to maneuver freely;
a straight wall section distending axially below said small diameter of said truncated conically shaped outer basket with a disposable bag attaching means;
4 bottom bearing support rods extending radially inward towards
a bottom raceway and bearing from said small diameter at bottom of said truncated conically shaped outer basket;
an animal food supply attached to said cylindrical exterior wall on opposite side of said trap case from said animal run;
a plate assembly that mounts on top of and inside said case assembly comprised of:
a round steel plate with a top side, a bottom side and a periphery and a concentrically located top raceway and bearing,
a drive shaft axially inserted through said top bearing and keyed into
a motor with a timer where said motor is cycled by said timer for predetermined periods of time at predetermined intervals, supported with a minimum of three
stabilizer bars above said top plate, where said drive shaft has at least
one steel cutter blade axially attached where said cutter blade's distal edge has the same shape as the inside of said inner basket and the radius to the distal edge of said cutter blade is 0.002/0.005 inches less than the radius of said inner basket;
an inner basket with a truncated conical shape with the large diameter at the top and the small diameter at the bottom concentrically attached to said bottom side of said steel plate with sufficiently smaller diameters as to provide approximately 0.5 inch space between said outer basket and said inner basket with three evenly placed spacer blocks fastened to the outside toward the bottom of said inner basket to aid in maintaining even spacing;
rows of evenly spaced perforations in said inner and outer baskets where said perforations are small enough to prevent bed bugs and roaches from crawling through said perforations but allow the pests to see, smell and hear bait animal, where the span of said evenly spaced rows of perforations is smaller than the height of said cutter blade and are contained within said height of said cylindrical trap case and are large enough to allow the insect's legs to stick through the perforations to be amputated by said cutter blade;
vents through said top plate are located just outboard of said inner basket's top diameter and just inside said outer basket's top diameter to allow any odors that potentially are attractive to said bed bugs and roaches to escape and is the place where
a cloth strip bug ladder's distal end is inserted into said vent while said cloth strip bug ladder's proximal end is allowed to drag the floor providing access to said bugs into said trap; and
two handle/latches pivotally mounted toward said periphery of said top plate for lifting and inserting said plate assembly into said trap case assembly and rotating said handle/latches locking said plate assembly to said trap case assembly;
a cage assembly for a warm blooded bait animal comprised of an enclosure where a small warm blooded animal, such as a mouse, has a water supply and air circulation system encased in a transparent medium such that odors attractive to bedbugs and roaches are forced from said cage through said animal run into said case assembly and out through a plate assembly vent and said cage is protected from bed bug or roach encroachment by said encasement.
